(19) United States
(12) Patent Application Publication
(10) Pub. No.: US 2009/0219295 A1
(43) Pub. Date: Sep. 3, 2009

(54) Display System and Method for Reducing Power Consumption of Same

(75) Inventor: Jozef Hubert Reijnaerts, Heerlen (NL)

Correspondence Address: LIU & LIU, 444 S. FLOWER STREET, SUITE 1750, LOS ANGELES, CA, 90071, US

(73) Assignee: TPO Displays Corp., Chu-Nan (TW)

(21) Appl. No.: 12/323,817

(22) Filed: Nov. 26, 2008

Related U.S. Application Data
(60) Provisional application No. 60/989,989, filed on Nov. 26, 2007.

(51) Int. Cl. G06F 15/00

(52) U.S. Cl. 345/501

(57) ABSTRACT

For reducing power consumption of a display, whether a currently received frame data is different from a currently displayed frame data or not is discriminated. If the currently received frame data is different from the currently displayed frame data, execute data refresh in a normal way. If the currently received frame data is not different from the currently displayed frame data, suspend data refresh for saving power.

### CROSS REFERENCE TO RELATED PATENT APPLICATION

This patent application is based on a U.S. provisional patent application No. 60/989,989 filed Nov. 26, 2007.

### FIELD OF THE INVENTION

The present invention relates to a method for reducing power consumption of a display system, and more particularly to a method performing new-image recognition for reducing power consumption of a display system. The present invention also relates to a display system exhibiting reduced power consumption.

### BACKGROUND OF THE INVENTION

In response to an image signal from a host, a driver IC drives the panel to reveal inputted or updated image data. Please refer to FIG. 1A and FIG. 1B, a display device 12 is optionally built with a display memory 121, e.g. a RAM (random accessed memory), for storing a pixel data array representing an image received from a host 11 via a driver IC 122. For interfaces like CDP (Continuous Data Protection) or RGB, the display data are continuously sent to a display panel 123 without a display memory at a high refresh rate, as illustrated in FIG. 1A. On the other hand, if a display memory 121 is built in the driver IC 122, as illustrated in FIG. 1B, the image data are written into the memory 121 and displayed subsequently, for example, in a refresh-burst manner. In this case, the refresh rate is defined inside the driver IC 122, and the internal refresh rate of the memory 121 is generally high to avoid delay in or slow update of a new image. For executing high-rate refresh, all circuits in the display device 12 should remain active and run at a high frequency, and thus high power consumption is incurred. For example, a flash memory (used for AMOLED) consumes a relatively large power at a high refresh-rate (about 40 mW estimated at 65 Hz refresh-rate). Since a periodically refresh process is executed but the displayed image is not always changing, it is likely to redundantly rewrite information without any modification to the displayed image, and thus waste power for no reason.

### SUMMARY OF THE INVENTION

Therefore, the present invention provides a display system exhibiting reduced power consumption and a method for reducing power consumption of a display system by executing refresh only when a new image is recognized.

The present invention relates to a method for reducing power consumption of a display. The method includes steps of: discriminating whether a currently received frame data is different from a currently displayed frame data or not; suspending data refresh if the currently received frame data is not different from the currently displayed frame data; and executing data refresh if the currently received frame data is different from the currently displayed frame data.

In an embodiment, the discriminating step includes: calculating a characteristic parameter of the currently received frame data; comparing the characteristic parameter of the currently received frame data with the characteristic parameter of the currently displayed frame data; determining that the currently received frame data is not different from the currently displayed frame data when the characteristic parameters match each other; and determining that the currently received frame data is different from the currently displayed frame data when the characteristic parameters do not match.

In another embodiment, the discriminating step is executed by a host outputting the currently received frame data to the display, and the host issues a new-image signal to have the display execute the data refresh when the currently received frame data is different from the currently displayed frame data which is previously outputted to the display by the host.

In a further embodiment, the discriminating step includes: detecting memory-write access of a display memory disposed in the display for storing frame data; determining that the currently received frame data is not different from the currently displayed frame data if there is no new data written into the display memory; and determining that the currently received frame data is different from the currently displayed frame data when there is new data written into the display memory.

The present invention also provides a display system, which includes: a display panel; a host for providing a frame data to be displayed by the display panel; and a driver IC coupled between the host and the display panel for receiving the frame data and driving the display panel to show the frame data. The driver IC determines whether a newly received frame data is new, suspends data refresh if the newly received frame data is not new, and executes data refresh if the newly received frame data is new.

### BRIEF DESCRIPTION OF THE DRAWINGS

The above contents of the present invention will become more readily apparent to those ordinarily skilled in the art after reviewing the following detailed description and accompanying drawings, in which:

FIG. 1A is a functional block diagram illustrating a conventional display system without a display memory;

FIG. 1B is a functional block diagram illustrating another conventional display system with a display memory;

FIG. 2A is a functional block diagram illustrating a display system without a display memory according to an embodiment of the present invention;

FIG. 2B is a flowchart summarizing a method for reducing power consumption of the display of FIG. 2A according to an embodiment of the present invention;

FIG. 3A is a functional block diagram illustrating a display system with a display memory according to an embodiment of the present invention; and

FIG. 3B is a flowchart summarizing a method for reducing power consumption of the display of FIG. 3A according to an embodiment of the present invention.

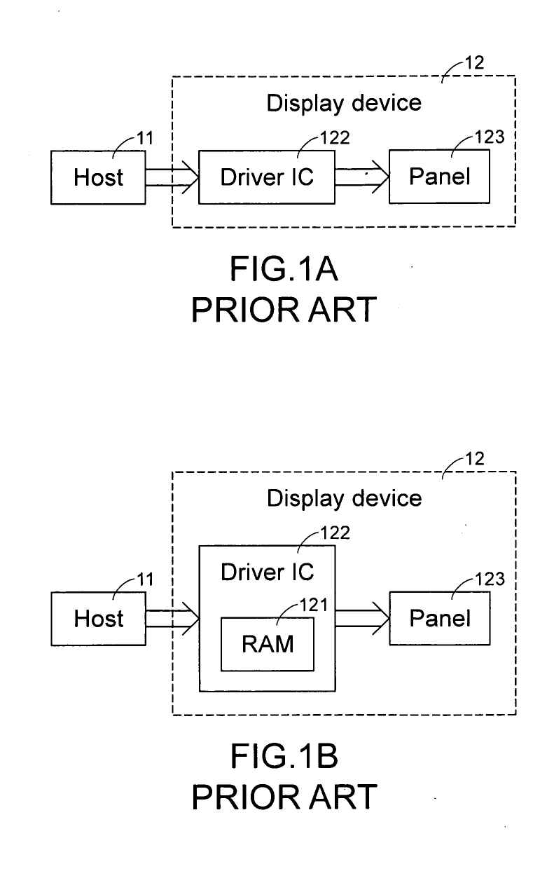

### DETAILED DESCRIPTION OF THE PREFERRED EMBODIMENT

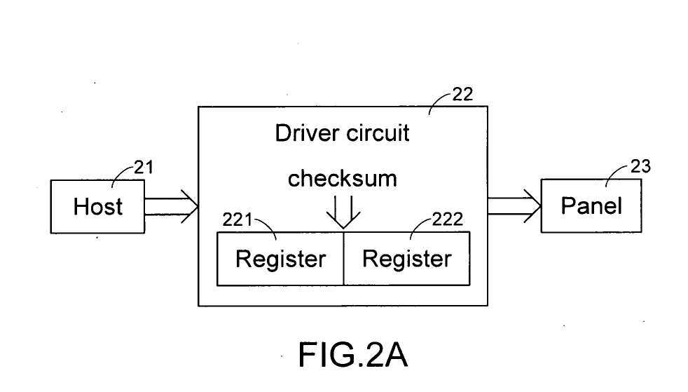

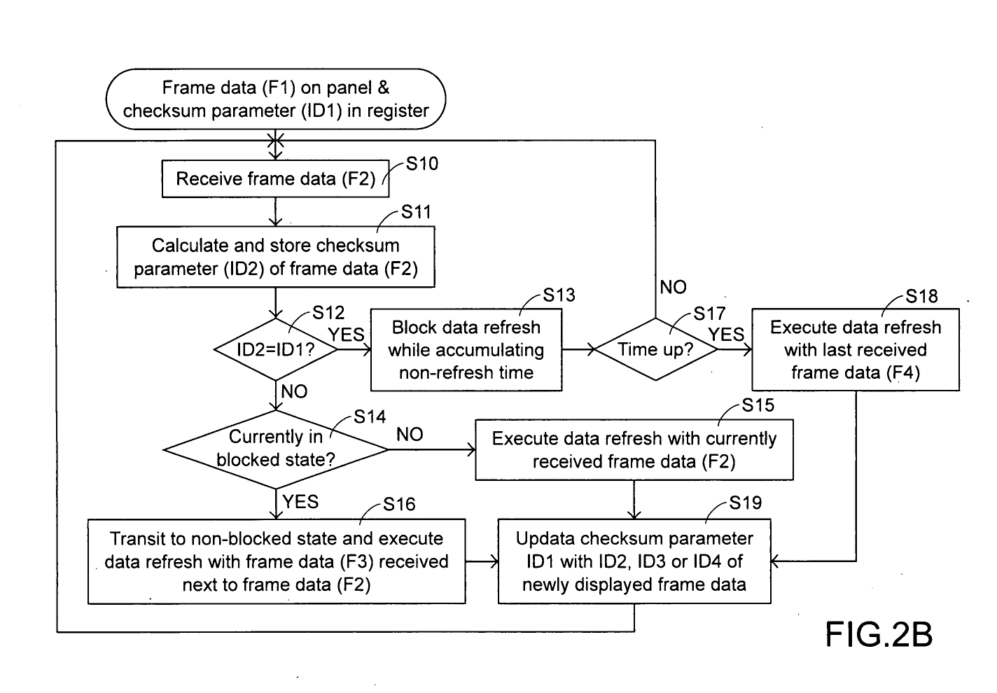

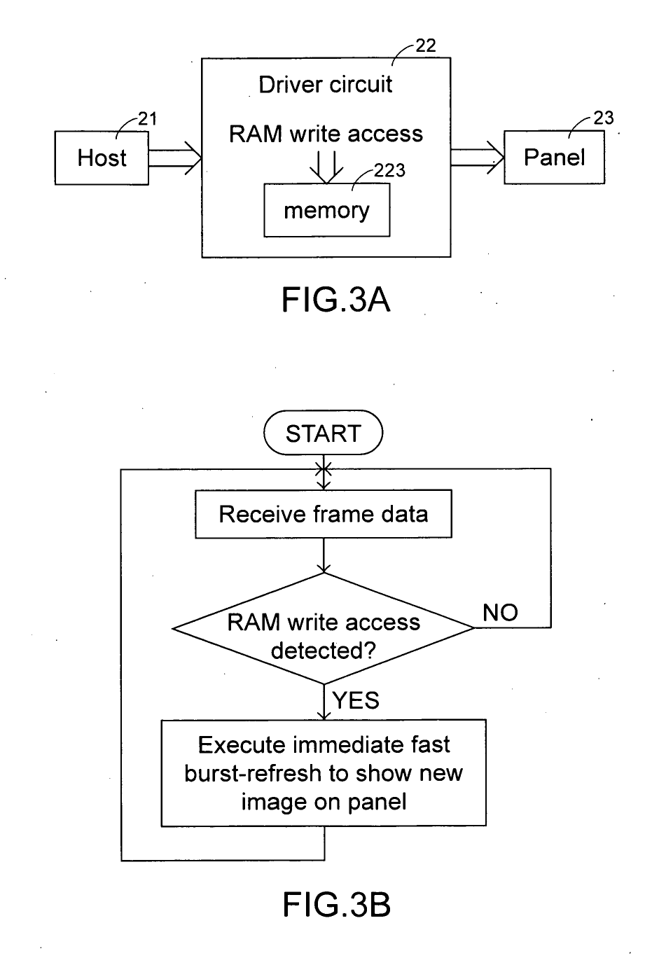

For reducing power consumption, a new-image-recognition operation is performed according to the present invention, and refresh is executed only when a new (different) image is recognized. Hereinafter, embodiments of power-saving methods for use in a display system without a display memory and a display system with a display memory according to the present invention are illustrated with reference to FIG. 2A and FIG. 3A, respectively.

A display system principally includes a host 21, a driver circuit 22 and a display panel 23. Receiving an image signal from the host 21, the driver IC 22 drives the display panel 23 to reveal image data. According to the present invention, a newly received image signal is checked to see if it is a new image, i.e. if it is different from the image being displayed by the panel 23 to a certain extent. Once a new image is recognized, data refresh of the display panel is normally executed. Otherwise, the coming data are blocked and keep last non-blocked frame on the panel until next new image is processed. In the embodiment of display shown in FIG. 2A, the display system does not include a display memory, and data are intermittently blocked by way of gating.

“Gating” is a process of virtually disconnecting non-participating devices during a certain period. By temporarily switching off the unused devices, power-saving can be achieved. Likewise, by gating off logic and clock sources to reduce the substantial refresh rate, power consumption resulting from a high refresh rate of images can be reduced. For example, gating is effective for reducing power consumption of an AMOLED or TFT-AMLCD panel, particularly an AMOLED panel due to the DC-nature of the LED and low leak panel-design as well as the large power consumption thereof at a high refresh rate. Between the refresh-bursts a significant part of the panel-driver and flash memory can be switched off so as to reduce power consumption. For example, assuming 65 mW is dissipated at a 65 Hz refresh rate, then the power consumption will be reduced to 65 mW/65 Hz=1 mW if the refresh rate is reduced to 1 Hz by gating. Furthermore, for still images which do not need frequent refresh, power saving can be achieved by gating without sacrificing image quality. This method is also useful in UI mode or video mode with a lot of still frames in it.

As for the determination of a new image, it is executed by comparing checksum parameters of the newly received image and the currently displayed image in an embodiment of the present invention. As known to those skilled in the art, the operation of checksum is a way to protect the integrity of a data and can be variously implemented. Basically, one or more specified operations of the data are performed to obtain a checksum parameter, which is properly stored. Afterwards, one may perform the same operation(s) and compare the operated result with the stored value to see if there is any error occurring. The sophisticated the checksum, the precise the error-check effect. A CRC (cyclic redundancy check) code is an example of such a checksum. As known to those skilled in the art, a CRC code is an error-detecting code which is obtained by a long division computation of a value representing a transmitted data block and equals to the remainder of the division computation. Therefore, the checksum parameter of a data, which is obtained by CRC or any other suitable algorithm, is substantially characteristic. By comparing respective checksum parameters, whether image changes or not can be detected. It is preferred the checksum is long enough so as to precisely detect the change of images. Nevertheless, less sophisticated checksum can be used if less power consumption is desired rather than better image quality.

Alternatively, the determination of a new image can be executed by the host 21, and the host 21 sends a new-image signal along with the image signal to the driver circuit 22 when a new image is recognized.

FIG. 2B is a flowchart briefly summarizing the above-mentioned gating process. When receiving an image signal from the host 21 (Step S10), a checksum parameter (ID2) of the newly received frame data (F2) is calculated by the driver circuit 22 and stored in a register 221 of the driver circuit 22 (Step S11). The checksum parameter (ID2) is then compared with a checksum parameter (ID1) of last non-blocked frame data (F1) currently displayed on the panel 23, which is stored in a register 222 of the driver circuit 22 (Step S12). If ID2 is equal to ID1, it is determined that the newly received image (F2) is not new and thus blocked from being displayed on the panel 23 (Step S13). On the other hand, if the checksum parameters (ID1 and ID2) are not equal, check if the currently received frame data (F2) is in an inherently blocked state, e.g. preceding frame (F1′) has been blocked (blocked state) or passed (non-blocked state) (Step S14). If the currently received frame data (F2) is in a non-blocked state, pass the frame data (F2) to be displayed by the panel 23 (Step S15). Otherwise, transit the state to a non-blocked state and refresh the currently displayed frame data (F1) with frame data (F3) coming next to the compared frame data (F2) (Step S16). In this case, only one frame will be lost. In spite new-image recognition is the key point for determining whether the data refresh is to be executed, the panel 23 had better not wait too long to refresh frame data displayed thereon. Therefore, even if the checksum parameters ID1 and ID2 are equal in the discriminating step S12, data refresh is still executed after a predetermined period of non-refresh time is due by refreshing the currently displayed frame data (F1) with frame data (F4) last received while time is up (Step S17 and S18). Meanwhile, the checksum parameter (ID1) to be compared with is updated with those (ID2, ID3 or ID4) of the newly displayed frame data (F2, F3 or F4) (Step S19).

In the above embodiment, checksum such as CRC is used as a parameter to determine whether the image changes or not. Alternatively, other characteristic features of an image frame, e.g. luminance, can also be used for new image recognition.

Please refer FIG. 3A in which another embodiment of display system is illustrated. The display system includes a display memory 223 inside the driver circuit 22. When recognizing a new image written to the display memory 223, the driver circuit 22 executes immediate fast burst-refresh to refresh frame data displayed on the panel 23. The new-image recognition is done by detecting RAM write access of the display memory 223. If RAM write access to the display memory 223 is executed, data refresh cycles are immediately executed in succession within a given period. This method is summarized in the flowchart of FIG. 3B.

To sum up, according to the present invention, no matter if there is a display memory provided in the display system, data refresh of the panel will be executed only when a new image is recognized or a maximum waiting time for a new image is due. Therefore, power consumption of the display system can be reduced. The display system, for example, can be a mobile phone, a digital camera, a personal digital assistant (PDA), a laptop computer, a desktop computer, a television set, a car display, a navigator with global positioning system (GPS), an aviation display, a digital photo frame, a portable DVD player, or any other suitable electronic apparatus with a display.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for reducing power consumption of a display system, comprising steps of:
discriminating whether a currently received frame data is different from a currently displayed frame data or not;
suspending data refresh if the currently received frame data is not different from the currently displayed frame data; and
executing data refresh if the currently received frame data is different from the currently displayed frame data.

2. The method according to claim 1 wherein the discriminating step includes:
calculating a characteristic parameter of the currently received frame data;
comparing the characteristic parameter of the currently received frame data with the characteristic parameter of the currently displayed frame data;
determining that the currently received frame data is not different from the currently displayed frame data when the characteristic parameters match each other; and
determining that the currently received frame data is different from the currently displayed frame data when the characteristic parameters do not match.

3. The method according to claim 2 wherein the characteristic parameters are checksum values.

4. The method according to claim 2 wherein the characteristic parameters are CRC (cyclic redundancy check) values.

5. The method according to claim 1 wherein new frame data are continuously received and discriminated, and the method further comprises accumulating non-refresh time while continuously suspending received frame data, and executing data refresh with last received frame data when a predetermined period of non-refresh time is due.

6. The method according to claim 1 wherein the data refresh is executed with the currently received frame data if the currently received frame data is in a non-blocked state.

7. The method according to claim 1 wherein the data refresh is executed with a frame data received next to the currently received frame data if the currently received frame data is in a blocked state.

8. The method according to claim 1 wherein the discriminating step is executed by a host outputting the currently received frame data to the display, and the host issues a new-image signal to have the display execute the data refresh when the currently received frame data is different from the currently displayed frame data which is previously outputted to the display by the host.

9. The method according to claim 1 wherein the discriminating step includes:
detecting memory-write access of a display memory disposed in the display for storing frame data;
determining that the currently received frame data is not different from the currently displayed frame data if there is no new data written into the display memory; and
determining that the currently received frame data is different from the currently displayed frame data when there is new data written into the display memory.

10. A display system, comprising:
a display panel;
a host for providing a frame data to be displayed by the display panel; and
a driver IC coupled between the host and the display panel for receiving the frame data and driving the display panel to show the frame data;
wherein the driver IC determines whether a newly received frame data is new, suspends data refresh if the newly received frame data is not new, and executes data refresh if the newly received frame data is new.

11. The display system according to claim 10 wherein the newly received frame data is determined to be new when the newly received frame data is different from a frame data currently displayed by the display panel.

12. The display system according to claim 10 wherein the driver IC is disposed therein a first register for storing a checksum parameter of the currently displayed frame data and a second register for storing a checksum parameter of the newly received frame data, wherein the checksum parameter stored in the second register is compared with the checksum parameter stored in the first register to determine whether the newly received frame data is new.

13. The display system according to claim 10 wherein the driver IC is disposed therein a memory for storing the newly received frame data, wherein the driver IC determines whether the newly received frame data is new by detecting RAM write access to the memory, and executes immediate fast burst-refresh to refresh frame data displayed on the display panel 23 if the newly received frame data is new.

14. The display system according to claim 10 wherein the display panel is an OLED panel.

15. The display system according to claim 10 being selected from a group consisting of a mobile phone, a digital camera, a personal digital assistant (PDA), a laptop computer, a desktop computer, a television set, a car display, a navigator with global positioning system (GPS), an aviation display, a digital photo frame, and a portable DVD player.
